(19) United States
(12) Patent Application Publication
(10) Pub. No.: US 2026/0302916 A1
(43) Pub. Date: Oct. 1, 2026

(54) LOW POWER CONSUMPTION ADAPTIVE CONTROL METHOD, CONTROL DEVICE OF ISOLATED CONVERTER AND ISOLATED CONVERTER

(71) Applicant: Joulwatt Technology Co., Ltd., Hangzhou City (CN)

(72) Inventors: Yang YANG, Hangzhou (CN); Pitleong WONG, Hangzhou (CN)

(21) Appl. No.: 19/575,193

(22) Filed: Mar. 23, 2026

(30) Foreign Application Priority Data
Mar. 26, 2025 (CN) 202510368695.7

(51) Int. Cl. H02M 1/00

(52) U.S. Cl. CPC H02M 1/0035; H02M 1/0012

(57) ABSTRACT

A low power consumption adaptive control method, a control device and an isolated converter are disclosed. The isolated converter comprises a primary side control chip, an isolated communication unit, and a secondary side main control chip. The low power consumption adaptive control method comprises: in response to a low power consumption control instruction, the secondary side main control chip sending a low power consumption signal to the primary side control chip through the isolated communication unit, so that the primary side control chip controls the primary side demodulation chip to perform hiccup power supply based on regular inspection, and the secondary side main control chip controls the secondary side modulation chip to perform hiccup power supply based on the output voltage of the isolated converter. The present disclosure adaptively controls power supply status, which significantly reduces overall power consumption while meeting communication requirements and adapting to different application scenarios.

### CROSS-REFERENCE TO RELATED APPLICATIONS

This present disclosure claims priority to a Chinese patent application No. 202510368695.7, filed on Mar. 26, 2025, and entitled “Low Power Consumption Adaptive Control Method, Control Device of Isolated Converter and Isolated Converter”, the entire contents of which are incorporated herein by reference, including the specification, claims, drawings and abstract.

### FIELD OF TECHNOLOGY

The present disclosure relates to the field of technical field of isolated converter, more particularly, to a low power consumption adaptive control method, control device of an isolated converter, and an isolated converter.

### BACKGROUND

Isolated converter, as an important component of power supply applications, plays a crucial role in chargers for electronic devices such as mobile phones and laptops. In order to improve charging efficiency, charging technology based on fast charging (Power Delivery, PD) protocol has been widely used in the chargers of such electronic devices.

In related technologies, isolated converters generally achieve primary side and secondary side communication through capacitive isolators, thereby achieving stable operation of the power supply. With the continuous improvement of energy conservation and emission reduction requirements, users put forward the demand for “zero standby energy consumption” (energy consumption less than 5 mW) for fast chargers. However, a capacitive isolator itself has high static power consumption, making it difficult for fast chargers to meet the performance requirements of low power consumption.

### SUMMARY OF THE DISCLOSURE

The present disclosure provides a low power consumption adaptive control method, control device of an isolated converter, and an isolated converter, which solves the problem that difficult to meet the performance requirements of low power consumption for fast chargers, caused by high static power consumption of present isolated converters. The static power consumption of the primary side demodulation chip and the secondary side modulation chip is reduced by hiccup power supply, and the power supply status of the primary side demodulation chip and the secondary side modulation chip can be adaptively controlled according to the change of the output voltage of the isolated converter. While significantly reducing the overall power consumption of the isolated converter, it can also meet the normal communication requirements of the isolated converter, improve the adaptability of the system to different application scenarios, and meet diversified needs.

In order to achieve the above objectives, the technical solutions mainly used by the present disclosure comprise:

In the first aspect, embodiments of the present disclosure provide a low power consumption adaptive control method of an isolated converter, wherein the isolated converter comprises a primary side control chip, an isolated communication unit, and a secondary side main control chip; the primary side control chip is configured to supply power to the primary side demodulation chip of the isolated communication unit, and the secondary side main control chip is configured to supply power to the secondary side modulation chip of the isolated communication unit, wherein the low power consumption adaptive control method comprises:
in response to a low power consumption control instruction, the secondary side main control chip sends the low power consumption signal to the primary side control chip through the isolated communication unit, so that the primary side control chip controls the primary side demodulation chip to perform hiccup power supply based on regular inspections, and the secondary side main control chip controls the secondary side modulation chip to perform hiccup power supply based on the output voltage of the isolated converter.

The low power consumption adaptive control method proposed in the embodiment of the present disclosure, responds to low power consumption control instructions through a secondary main control chip, and sends the low power consumption signal to the primary side control chip through an isolated communication unit, the secondary side main control chip controls the secondary side modulation chip to perform hiccup power supply based on the output voltage of the isolated converter. When the primary side control chip receives the low power consumption signal, it controls the primary side demodulation chip to perform hiccup power supply based on regular inspections. Therefore, the present disclosure can use hiccup power supply to control the power supply of the primary side demodulation chip and the secondary side modulation chip separately, avoiding the problem of high power consumption caused by continuous power supply; moreover, it can also dynamically adjust the power supply of the secondary side modulation chip based on the output voltage of the isolated converter, and control the primary side demodulation chip to perform hiccup power supply based on regular inspections, achieving adaptive control of the power supply status of the primary side demodulation chip and the secondary side modulation chip. This not only significantly reduces the overall power consumption of the isolated converter, but also meets the normal communication requirements of the isolated converter, improves the adaptability of the system to different application scenarios, and meets the diversified needs of the isolated converter.

Optionally, in some embodiments of the present disclosure, the secondary side modulation chip is controlled to perform hiccup power supply based on the output voltage of the isolated converter, comprising:
in the case that the output voltage of the isolated converter decreases to the first preset voltage threshold, turning on the power supply to the secondary side modulation chip, so that in the case that the output voltage of the isolated converter rises to the second preset voltage threshold, turning off the power supply to the secondary side modulation chip, wherein the second preset voltage threshold is greater than the first preset voltage threshold.

The power supply to the secondary side modulation chip is dynamically turned on and turned off based on the output voltage of the isolated converter. When the output voltage is low, turning on the power supply to the secondary side modulation chip helps to increase the output voltage and ensures the normal operation of the system. When the output voltage rises to a certain level, the power supply to the secondary side modulation chip is turned off to avoid unnecessary power consumption of the secondary side modulation chip, achieve effective management of the power consumption of the secondary side modulation chip, further reduce the overall power consumption of the isolated converter, and improve energy utilization efficiency.

Optionally, in some embodiments of the present disclosure, when the power supply to the secondary side modulation chip is turned on, the method further comprises:
the secondary side main control chip sends the switch control signal to the primary side control chip through the isolated communication unit, so that the primary side control chip controls the power switch transistor of the isolated converter based on the switch control signal, causing the output voltage of the isolated converter to rise.

The secondary side main control chip sends the switch control signal to the primary side control chip through isolated communication, so that the primary side control chip can control the power switch transistor according to the switch control signal sent from the secondary side, thus effectively adjusting the output voltage of the isolated converter, ensuring that the output voltage can be raised in a timely and effective manner when power supply to the secondary side modulation chip is turned on, maintaining the system output voltage at an appropriate level, and ensuring stable operation of the system.

Optionally, in some embodiments of the present disclosure, in the case that the secondary side main control chip sends the switch control signal to the primary side control chip through the isolated communication unit, the method further comprises:
determining the isolated converter has a communication fault if the secondary side main control chip does not detect the primary side response of the isolated converter within the first preset time period.

By detecting the primary side response of the isolated converter within the first preset time period, abnormal communication between the primary and secondary sides can be detected in a timely manner. If the secondary side main control chip does not receive the primary side response within the first preset time period, a communication fault is determined, which facilitates the system to take corresponding measures in a timely manner, such as issuing an alarm, conducting fault diagnosis, or switching to a backup communication path, etc. This helps to ensure the reliability of the isolated converter communication and maintain the stable operation of the system.

Optionally, in some embodiments of the present disclosure, during the process that the primary side control chip turns on power supply to the primary side demodulation chip, if a switch control signal sent by the secondary side modulation chip is detected, the power supply to the primary side demodulation chip is maintained until the primary side demodulation chip does not receive the switch control signal and continues for a second preset time period, and the power supply to the primary side demodulation chip is turned off.

During the process of enabling power supply to the primary side demodulation chip by the primary side control chip, the power supply to the primary side demodulation chip is maintained to ensure that the primary side control chip can effectively receive the switch control signal sent by the secondary side modulation chip. When switch control signal is not received, the power supply to the primary side demodulation chip is controlled to continue for a second preset time period before being turned off, effectively avoiding the situation where the primary side demodulation chip is powered off when there is a communication demand. In addition, the primary side control chip can also turn off the power supply to the primary side demodulation chip when the switch control signal is not received for a long time, avoiding the waste of power consumption of the primary side demodulation chip and greatly improving energy utilization efficiency.

Optionally, in some embodiments of the present disclosure, in the case that the secondary side main control chip receives an instruction to exit low power consumption, the method further comprises:
starting the power supply to the secondary side modulation chip, and sending the first wake-up signal to the primary side control chip through the isolated communication unit; and, when the primary side reply of the isolated converter is detected, sending the second wake-up signal to the primary side control chip through the isolated communication unit; the second wake-up signal is used to instruct the primary side control chip to restore power supply.

The secondary side main control chip sends the first wake-up signal to the primary side control chip through the isolated communication unit, and sends the second wake-up signal to the primary side control chip after confirming the response of the primary side, thereby achieving the orderly switching of the isolated converter from low power consumption mode to normal working mode, ensuring that the isolated converter can effectively recover to normal working state, and meeting the needs of the system to quickly recover from low power consumption state to normal operation.

In the second aspect, embodiments of the present disclosure provide a control device of an isolated converter, wherein comprising a primary side control chip, an isolated communication unit, and a secondary side main control chip; the primary side control chip is configured to supply power to the primary side demodulation chip of the isolated communication unit, and the secondary side main control chip is configured to supply power to the secondary side modulation chip of the isolated communication unit, wherein
the secondary side main control chip is further configured to respond to low power consumption control instructions, send the low power consumption signal to the primary side control chip through the isolated communication unit, and control the secondary side modulation chip to perform hiccup power supply based on the output voltage of the isolated converter;
the primary side control chip controls the primary side demodulation chip to perform hiccup power supply based on regular inspections in the case that receiving the low power consumption signal.

The control device proposed in the embodiments of the present disclosure, responds to low power consumption control instructions through a secondary side main control chip, and sends the low power consumption signal to the primary side control chip through an isolated communication unit. The secondary side modulation chip is controlled by the secondary side main control chip based on the output voltage of the isolated converter to perform hiccup power supply. When the primary side control chip receives the low power consumption signal, it controls the primary side demodulation chip to perform hiccup power supply based on regular inspections. Therefore, the present disclosure can use hiccup power supply to control the power supply of the primary side demodulation chip and the secondary modulation chip separately, avoiding the problem of high power consumption caused by continuous power supply. It can also dynamically adjust the power supply of the secondary side modulation chip based on the output voltage of the isolated converter, and control the primary side demodulation chip to perform hiccup power supply based on regular inspections, achieving adaptive control of the power supply status of the primary side demodulation chip and the secondary side modulation chip. This not only significantly reduces the overall power consumption of the isolated converter, but also meets the normal communication requirements of the isolated converter, improves the adaptability of the system to different application scenarios, and meets the diversified needs of the isolated converter.

Optionally, in some embodiments of the present disclosure, the secondary side main control chip is further configured to turn on the power supply to the secondary side modulation chip in the case that the output voltage of the isolated converter decreases to a first preset voltage threshold, and turn off the power supply to the secondary side modulation chip in the case that the output voltage of the isolated converter rises to a second preset voltage threshold, wherein the second preset voltage threshold is greater than the first preset voltage threshold.

The secondary side main control chip dynamically turns on and turns off the power supply to the secondary side modulation chip based on the output voltage of the isolated converter. When the output voltage is low, turning on the power supply to the secondary side modulation chip helps to increase the output voltage and ensure the normal operation of the system. When the output voltage rises to a certain level, turning off the power supply to the secondary side modulation chip can avoid unnecessary power consumption of the secondary side modulation chip, achieve effective management of the power consumption of the secondary side modulation chip, further reduce the overall power consumption of the isolated converter, and improve energy utilization efficiency.

Optionally, in some embodiments of the present disclosure, the secondary side main control chip is further configured to, in the case that power supply to the secondary side modulation chip is turned on, send a switch control signal to the primary side control chip through the isolated communication unit, so that the primary side control chip controls the power switch transistor of the isolated converter based on the switch control signal, causing the output voltage of the isolated converter to rise.

The secondary side main control chip sends the switch control signal to the primary side control chip through the isolated communication, so that the primary side control chip can control the power switch transistor according to the switch control signal sent from the secondary side, and thus effectively adjust the output voltage of the isolated converter, ensuring that the output voltage can be raised in a timely and effective manner when the power supply to the secondary side modulation chip is turned on, maintaining the system output voltage at an appropriate level, and ensuring the stable operation of the system.

Optionally, in some embodiments of the present disclosure, the secondary side main control chip is further configured to, in the case of sending the switch control signal to the primary side control chip through the isolated communication unit, if the primary side response of the isolated converter is not detected within the first preset time period, determine that the isolated converter has a communication fault.

The secondary side main control chip can detect communication abnormalities between the primary and secondary sides in a timely manner by detecting the primary side response of the isolated converter within the first preset time period. If the secondary side main control chip does not receive the primary side response within the first preset time period, it determines the communication fault and facilitates the system to take corresponding measures in a timely manner, such as issuing an alarm, conducting fault investigation, or switching to a backup communication path, etc, which helps to ensure the reliability of the isolated converter communication and maintain the stable operation of the system.

Optionally, in some embodiments of the present disclosure, the primary side control chip is further configured to, during the process of turning on the power supply to the primary side demodulation chip, if a switch control signal sent by the secondary side modulation chip is detected, maintain the power supply to the primary side demodulation chip until the primary side demodulation chip does not receive the switch control signal and continues for a second preset time period, and turn off the power supply to the primary side demodulation chip.

During the process of enabling power supply to the primary side demodulation chip by the primary side control chip, the power supply to the primary side demodulation chip is maintained to ensure that the primary side control chip can effectively receive the switch control signal sent by the secondary side modulation chip. When switch control signal is not received, the power supply to the primary side demodulation chip is controlled to continue for a second preset time period before being turned off, effectively avoiding the situation where the primary side demodulation chip is powered off when there is a communication demand. In addition, the primary side control chip can also turn off the power supply to the primary side demodulation chip when the switch control signal is not received for a long time, avoiding the waste of power consumption of the primary side demodulation chip and greatly improving energy utilization efficiency.

Optionally, in some embodiments of the present disclosure, the secondary side main control chip is further configured to, in the case that receiving a low power consumption exit instruction, starts power supply to the secondary side modulation chip, and sends a first wake-up signal to the primary side control chip through the isolated communication unit, and, in the case that detecting a primary side reply of the isolated converter, sends the second wake-up signal to the primary side control chip through the isolated communication unit, wherein the second wake-up signal is used to instruct the primary side control chip to restore power supply.

The secondary side main control chip sends the first wake-up signal to the primary side control chip through the isolated communication unit, and sends the second wake-up signal to the primary side control chip in the case that confirming the response of the primary side, thereby achieving the orderly switching of the isolated converter from low power consumption mode to normal working mode, ensuring that the isolated converter can effectively recover to normal working state, and meeting the needs of the system to quickly recover from low power consumption state to normal operation.

In the third aspect, embodiments of the present disclosure provide an isolated converter, comprising:
a converter;
a control device of the isolated converter according to the above embodiments.

The isolated converter proposed in the embodiments of the present disclosure, the isolated communication unit in the isolated converter is controlled to perform hiccup power supply through the above-mentioned control device to control, avoiding the problem of high power consumption caused by continuous power supply. It can also adaptively control the power supply of related modules based on the output voltage of the isolated converter, thereby significantly reducing the overall power consumption of the isolated converter while ensuring that the isolated converter can communicate according to actual needs, improving the adaptability of the system to different application scenarios, and meeting the diverse needs of the isolated converter.

### BRIEF DESCRIPTION OF THE DRAWINGS

In order to provide a clearer explanation of the specific implementation methods in the present disclosure or technical solutions in the existing technology, a brief introduction will be given to the accompanying drawings required for the specific implementation methods or existing technology description. It is obvious that the accompanying drawings in the following description are some implementation methods of the present disclosure. For those skilled in the art, other drawings can be obtained based on these drawings without creative efforts.

FIG. 1 is a schematic diagram of the circuit structure of an isolated switch power supply in related art;

FIG. 2 is a schematic diagram of the structure of a low power consumption adaptive control device of an isolated converter proposed in an embodiment of the present disclosure;

FIG. 3 is a flowchart of a low power consumption adaptive control method for an isolated converter proposed in an embodiment of the present disclosure;

FIG. 4 is a schematic diagram of signal timing during the low power consumption adaptive control process proposed in an embodiment of the present disclosure;

FIG. 5 is a schematic diagram of signal timing during the wake-up process proposed in an embodiment of the present disclosure

FIG. 6 is a schematic diagram of the structure of an isolated converter proposed in an embodiment of the present disclosure.

### DETAILED DESCRIPTION OF THE DISCLOSURE

In order to clarify the purpose, technical solution, and advantages of the embodiments of the present disclosure, the following will provide a clear and complete description of the technical solutions in the embodiments of the present disclosure in conjunction with the accompanying drawings. Obviously, the described embodiments are a part of the embodiments of the present disclosure, not all of them. Based on the embodiments in the present disclosure, all other embodiments obtained by those skilled in the art without creative efforts are within the protection scope of this application.

Isolated converters, as an important component of power applications, play a crucial role in chargers for electronic devices such as mobile phones and laptops, etc. In order to improve charging efficiency, PD protocol-based charging technology has been widely used in the chargers of these electronic devices. PD protocol is a fast charging standard based on USB Type-C interface, which can support power output of 100 W or even higher, greatly improving charging speed and meeting the fast charging needs of different devices.

With the continuous improving requirements for energy conservation and emission reduction, users have put forward a demand for “zero standby energy consumption” for fast chargers, where “zero standby energy consumption” generally refers to standby energy consumption less than 5 milliwatts (mW).

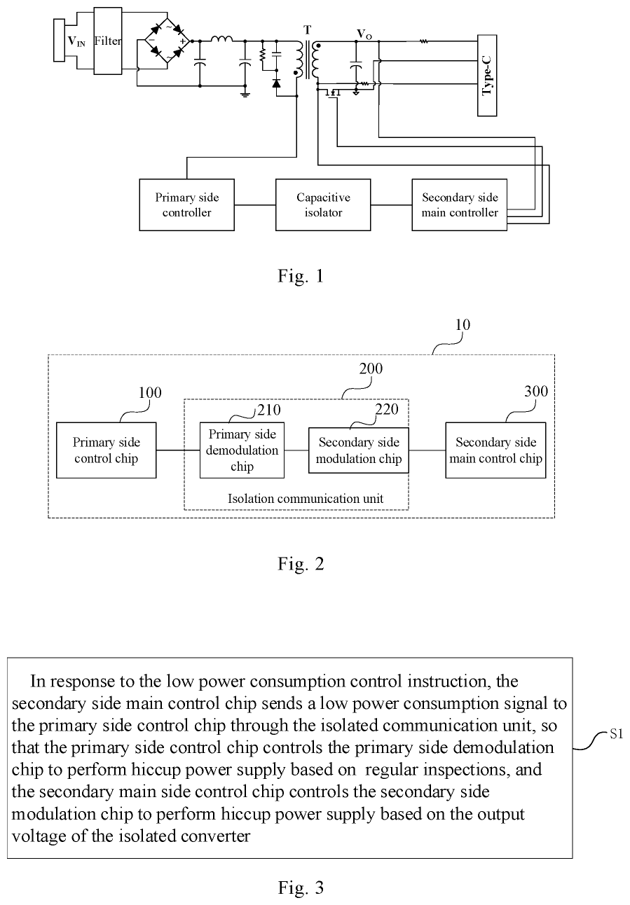

As shown in FIG. 1, in some application scenarios, the isolated switching power supply controlled by the secondary side generally comprises a secondary side main controller, a capacitive isolator, and a primary side controller, wherein the secondary side main controller transmits the control signal to the primary side controller through the capacitive isolator, so that the primary side controller responds to the control signal to drive the on and off of the primary side switch transistor, thereby converting the input voltage V_{IN} on the primary side into the output voltage V_{O} on the secondary side.

In related technologies, isolated converters generally achieve communication between primary and secondary side through capacitive isolators, thereby achieving stable operation of the power supply. With the continuous improvement of energy conservation and emission reduction requirements, users have put forward the demand for “zero standby energy consumption” (energy consumption less than 5 mW) for fast chargers. However, in order to ensure effective communication of the isolated converter, the capacitive isolator needs to maintain the working state at all times, which leads to the high static power consumption characteristics of the capacitive isolator itself. The static current at the transmitting end of a typical capacitive isolator is 2 milliamperes (mA), and the static current at the receiving end of the capacitive isolator is 1 mA. The primary side supply voltage is 10V, and the secondary side supply voltage is 5V. Therefore, without considering power loss, the static power consumption of the capacitive isolator itself is 20 mW. Considering the static current of the primary and secondary sides at 60 microamperes (μA), the static power consumption of the primary side controller, the secondary side main controller, and related circuits is about 1.2 mW, which leads to a high energy consumption level of the charger in standby mode, making it difficult to meet the performance requirements of fast chargers for static power consumption below 5 mW. Moreover, the high standby energy consumption will also result in the problem of overheating of fast chargers, affecting users' charging experience.

According to an embodiment of the present disclosure, a low power consumption adaptive control method of an isolated converter is provided. It should be noted that the steps shown in the flowchart of the accompanying drawings can be executed in a computer system such as a set of computer executable instructions, and although the logical sequence is shown in the flowchart, in some cases, the steps shown or described may be executed in a different order than here.

In this embodiment, a low power consumption adaptive control method of an isolated converter is provided, which can be used for the aforementioned mobile terminals, such as mobile phones, laptops, and other electronic devices. As shown in FIG. 2, the isolated converter comprises a primary side control chip 100, an isolated communication unit 200, and a secondary side main control chip 300. The primary side control chip 100 is suitable for supplying power to the primary side demodulation chip 210 of the isolated communication unit 200, and the secondary side main control chip 300 is suitable for supplying power to the secondary side modulation chip 220 of the isolated communication unit 200. As shown in FIG. 3, the method comprises the following steps:
Step S1, in response to the low power consumption control instruction, the secondary side main control chip 300 sends a low power consumption signal to the primary side control chip 100 through the isolated communication unit 200, so that the primary side control chip 100 controls the primary side demodulation chip 210 to perform hiccup power supply based on regular inspections, and the secondary side main control chip 300 controls the secondary side modulation chip 220 to perform hiccup power supply based on the output voltage of the isolated converter.

Specifically, hiccup power supply is an intermittent power supply mode. In the normal operation of the isolated converter, the primary side control chip 100 continuously supplies power to the primary side demodulation chip 210, and the secondary side main control chip 300 continuously supplies power to the secondary side modulation chip 220 to maintain the continuous and normal operation of the system. When performing hiccup power supply, the primary side control chip 100 and the secondary side main control chip 300 will periodically pause and resume power supply, respectively, so as to put the isolated communication unit 200 into a low power consumption state during the pause of power supply, and complete key operations such as signal transmission and reception during the brief restoration of power supply to maintain the necessary isolated communication function. Therefore, hiccup power supply can effectively reduce the overall average power consumption without affecting the key functions of the isolated converter.

Furthermore, in some embodiments of the present disclosure, the output terminal of the isolated converter is equipped with a Type-C output port configured to a fast charger, and a low power consumption control command will be generated when the plugged cable in the Type-C output port is unplugged. in the case that receiving low power consumption control instructions, the secondary side main control chip 300 generates the low power consumption signal and sends the low power consumption signal to the primary side control chip 100 through the isolated communication unit 200. Meanwhile, the secondary side main control chip 300 can control the secondary side modulation chip 220 to perform hiccup power supply according to the output voltage of the isolated converter. Therefore, the power supply time of the secondary side modulation chip 220 can be adaptively adjusted based on the actual load situation of the isolated converter, improving the flexibility of hiccup power supply.

When the primary side control chip 100 receives the low power consumption signal sent by the secondary side main control chip 300, it starts to perform the hiccup power supply to the primary side demodulation chip 210 through regular inspections. That is, the primary side control chip 100 starts the power supply to the primary side demodulation chip 210 at a preset cycle, and each power supply lasts for a certain period of time. The primary side demodulation chip 210 will demodulate the signal sent by the secondary side modulation chip 220 during the power supply period, and send the demodulated signal to the primary side control chip 100. During the non-power supply period, it will stop working, thereby minimizing the unnecessary power consumption of the primary side demodulation chip 210 in a low power consumption state.

Therefore, the present disclosure can supply power to the primary side demodulation chip 210 and the secondary side modulation chip 220 separately by way of hiccup power supply, avoiding the problem of high power consumption caused by continuous power supply. It can also dynamically adjust the power supply of the secondary side modulation chip 220 based on the output voltage of the isolated converter, and control the primary side demodulation chip 210 to perform hiccup power supply based on regular inspections, achieving adaptive control of the power supply status of the primary side demodulation chip 210 and the secondary side modulation chip 220. This not only significantly reduces the overall power consumption of the isolated converter, but also meets the normal communication requirements of the isolated converter, improves the adaptability of the system to different application scenarios, and meets diversified needs.

It should be noted that in some embodiments of the present disclosure, the above isolated converter also comprises a protocol chip, which is used to exchange information with electronic devices such as mobile phones and laptops through PD protocol, and works in conjunction with the primary side control chip and the secondary side main control chip to ensure that a suitable charging connection can be established between the isolated converter and the device.

In some embodiments of the present disclosure, the above step S1 further comprises: in the case that the output voltage of the isolated converter decreases to a first preset voltage threshold, turning on the power supply to the secondary side modulation chip 220, so that in the case that the output voltage of the isolated converter rises to a second preset voltage threshold, turning off the power supply to the secondary side modulation chip 220, wherein the second preset voltage threshold is greater than the first preset voltage threshold. Moreover, in the case that the power supply to the secondary side modulation chip 220 is turned on, the secondary side main control chip 300 sends the switch control signal to the primary side control chip 100 through the isolated communication unit 200, so that the primary side control chip 100 can control the power switching transistor of the isolated converter based on the switch control signal, causing the output voltage of the isolated converter to rise.

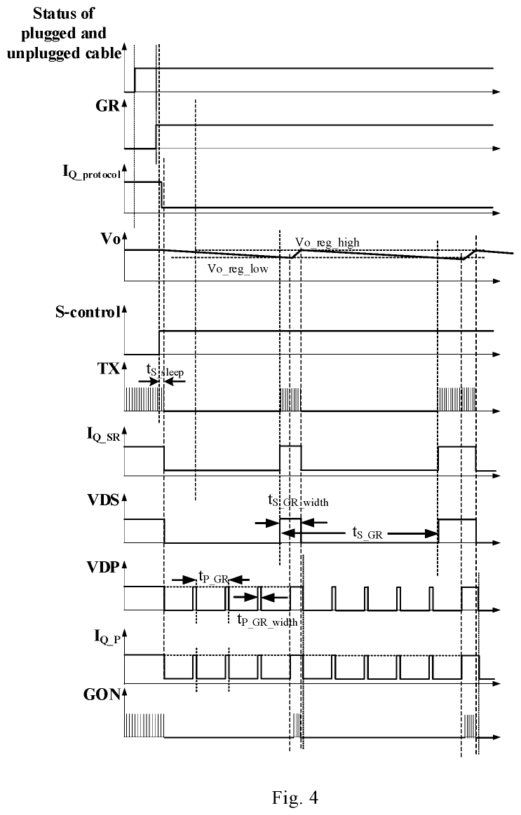

FIG. 4 shows the power supply timing situation for adaptive control of the secondary side modulation chip based on the output voltage of the isolated converter, where GR represents the control instruction sent to the secondary side main control chip, GR represents the low power consumption control instruction when it is a valid signal, and GR represents the instruction to exit low power consumption when it is an invalid signal. I_{Q_datocol} represents the static current of the protocol chip in the isolated converter. The protocol chip is generally 3.5 mA in normal operating mode and is typically pulled down to 50 microamperes (μA) in low power consumption mode. V_{O} represents the output voltage of the isolated converter, where V_{O_deg-low} represents the first preset voltage threshold and V_{O_deg-high} represents the second preset voltage threshold. S-control represents the mode control signal of the secondary side main control chip 300. When S-control is high, the secondary side main control chip 300 operates in low power consumption mode, and when S-control is low, the secondary side main control chip 300 operates in normal mode. TX represents the transmission signal of the secondary side modulation chip 220. VDS represents the power supply voltage of the secondary side main control chip 300 to the secondary side modulation chip 220, t_{S_GR_width} is the pulse width of VDS, which denotes the power supply time of the secondary side main control chip 300 to the secondary side modulation chip 220, and t_{S_GR} is the power supply cycle of VDS, which is synchronized with the cycle of TX. VDP represents the power supply voltage of the primary side control chip 100 to the primary side demodulation chip 210, t_{P_GR_width} is the pulse width of VDP, which denotes the power supply time of the primary side control chip 100 to the primary side demodulation chip 210, and t_{P_GR} is the power supply cycle of VDP when the primary side demodulation chip 210 does not receive TX signal, which is synchronized with the regular inspection cycle. I_{Q_SR} represents the static current of the secondary side main control chip 300. In normal operating mode, the I_{Q_SR} of the secondary side main control chip 300 is 2-3 mA, and in low power consumption mode, the I_{Q_SR} is around 50 μA. I_{Q-P} represents the static current of the primary side control chip 100. In normal operating mode, I_{Q-P} is 1~2 mA, and in low power consumption mode, I_{Q-P} is around 50 μA. GON represents the conduction signal of the power switch transistor, where GON indicates that the power switch transistor is turned on at high levels, and GON indicates that the power switch transistor is turned off at low levels.

Specifically, when the status signal of plugged and unplugged cable at the output end of the isolated converter is set to high level, the protocol chip converts the GR signal into a valid signal after a certain delay, i.e., generating a low power consumption control instruction and sending it to the secondary side main control chip 300. Meanwhile, the protocol chip switches to low power consumption mode, reducing the static current I_{Q_datocol} of the protocol chip to 50 μA. When the secondary side main control chip 300 detects that the GR signal has become a valid signal, it sets the S-control signal to a high level after a certain delay. When the secondary side modulation chip 220 detects the rising edge of the S-control signal, it modulates the low power consumption signal during the t_{S_stleep} period and sends the modulated TX signal to the primary side demodulation chip 210. Subsequently, both the secondary side modulation chip 220 and the secondary side main control chip 300 enter the low power consumption mode, and the static current I_{Q_SR} of the secondary side main control chip 300 becomes around 50 μA.

In the low power consumption mode, when the secondary side main control chip 300 detects that the output voltage V_{O} is less than V_{O_deg-low}, the secondary side main control chip 300 starts the power supply to the secondary side modulation chip 220, that is, the VDS signal is set to the power-on potential of the secondary side modulation chip 220, and remains at this power-on potential during the period when the output voltage V_{O} is greater than or equal to V_{O_deg-low} and less than V_{O_deg-high}, and the static current I_{Q_SR} of the secondary side main control chip 300 is synchronized with the VDS signal and kept at 2-3 mA. Meanwhile, the secondary side main control chip 300 generates switch control signals and sends the switch control signals to the secondary side modulation chip 220. The secondary side modulation chip 220 modulates the switch control signals and sends the modulated signal to the primary side demodulation chip 210 through the transmission terminal TX, so that the primary side control chip can control the power switch transistor of the isolated converter based on the switch control signals demodulated by the primary side demodulation chip 210, causing the output voltage V_{O} of the isolated converter to increase. As the output voltage V_{O} gradually increases, when the output voltage V_{O} of the isolated converter rises to V_{O_deg.high}, the secondary side main control chip 300 turns off the power supply to the secondary side modulation chip 220, that is, the VDS signal is set to zero potential and remains at zero potential during the period when the output voltage V_{O} is greater than V_{O_deg.low}.

It should be noted that during the power supply period from the secondary side main control chip 300 to the secondary side modulation chip 220, the TX signal is a pulse signal corresponding to the switch control signal, and this pulse signal is continuously transmitted at a certain frequency and fixed peak pulse width. If the time when the output voltage V_{O} rises to V_{O_deg.low} is within the current transmission cycle, need to wait for the end of the current transmission cycle before turning off the power supply, that is, the VDS signal needs to be reduced to zero potential after the end of the current transmission cycle.

Therefore, in some embodiments of the present disclosure, the power supply to the secondary side modulation chip 220 is dynamically turned on and turned off according to the amplitude of the output voltage V_{O} of the isolated converter. When the output voltage V_{O} is low, the power supply to the secondary side modulation chip 220 is turned on, which helps to improve the output voltage V_{O} and ensure the normal operation of the system, after the output voltage V_{O} rises to a certain level, the power supply to the secondary side modulation chip 220 is turned off, which can avoid unnecessary power consumption of the secondary side modulation chip 220, achieve effective management of the power consumption of the secondary side modulation chip 220, further reduce the overall power consumption of the isolated converter, and improve energy utilization efficiency. In addition, the secondary side main control chip 300 sends the switch control signal to the primary side control chip 100 through the isolated communication unit 200, so that the primary side control chip 100 can control the power switch transistor according to the switch control signal sent from the secondary side, effectively adjusting the output voltage V_{O} of the isolated converter, ensuring that the output voltage V_{O} can be timely and effectively increased when the secondary side modulation chip 220 is powered on, maintaining the system output voltage V_{O} at an appropriate level, and ensuring stable operation of the system.

In some embodiments of the present disclosure, in the case where the secondary side main control chip 300 sends the switch control signal to the primary side control chip 100 through the isolated communication unit 200, the method further comprises: if the secondary side main control chip 300 does not detect the primary side response of the isolated converter within the first preset time period, it is determined that the isolated converter has a communication fault.

Specifically, the transmitting end of the secondary side modulation chip 220 continuously sends TX signals at a minimum frequency of 25 KHz and a pulse width with a fixed peak, and the secondary side main control chip 300 can determine the primary side response by detecting whether the output voltage V_{O} on the secondary side changes. In some embodiments of the present disclosure, the first preset time period is set to 10 milliseconds (ms), and the response of the primary side is determined by the relevant parameters of the drain and source of the MOS transistor on the secondary side. If no changes in the relevant parameters are detected within 10 ms, it is determined that the primary side response of the isolated converter has not been detected. This indicates that the primary side control chip 100 has failed to effectively receive the switch control signal sent from the secondary side, thus determining that the isolated converter has a communication fault.

In some embodiments of the present disclosure, by detecting the primary side response of the isolated converter within the first preset time period, abnormal communication between the primary side and secondary side can be detected timely. If the secondary side main control chip 300 does not receive the primary side response within the first preset time period, a communication failure is determined, which facilitates the system to take corresponding measures in a timely manner, such as issuing an alarm, conducting fault investigation, or switching to a backup communication path, etc., which helps to ensure the reliability of the isolated converter communication and maintain the stable operation of the system.

In some embodiments of the present disclosure, during the process that the primary side control chip 100 starts the power supply to the primary side demodulation chip 210, if a switch control signal sent by the secondary side modulation chip 220 is detected, the power supply to the primary side demodulation chip 210 is maintained until the primary side demodulation chip 210 does not receive the switch control signal and continues for a second preset time period, at which point the power supply to the primary side demodulation chip 210 is turned off.

Specifically, as shown in FIG. 4, the static current I_{Q-P} of the primary side control chip 100 changes synchronously with the VDP signal of the primary side demodulation chip 210, and the static current I_{Q_SR} of the secondary side main control chip 300 changes synchronously with the VDS signal of the secondary side modulation chip 220. In the case that the primary side control chip 100 does not detect the switch control signal sent by the secondary side modulation chip 220, it maintains a regular inspection method with a fixed period t_{P_GR} and a fixed pulse width t_{P_GR_width} to supply power to the primary side demodulation chip 210. Wherein, in some embodiments of the present disclosure, t_{P_GR} can be set to 6 ms and t_{P_GR_width} can be set to 300 microseconds (μs).

Thus it can be seen that the primary side demodulation chip 210 will remain in operation within a pulse width of 300 μs. If the primary side demodulation chip 210 receives the TX signal sent by the secondary side modulation chip 220 during operation, it will demodulate the TX signal and send the demodulated switch control signal to the primary side control chip 100. When the primary side control chip 100 detects the switch control signal sent by the secondary side modulation chip 220, it maintains the control VDP signal at the power-on potential, allowing the GON signal to drive and control the power switch transistor on the primary side during this period, until the primary side demodulation chip 210 receives the last TX signal, and waits for the second preset time period after receiving the last TX signal before turning off the power supply to avoid accidental power supply shutdown. Wherein, in some embodiments of the present disclosure, the second preset time period can be set to 120 μs.

Therefore, in some embodiments of the present disclosure, during the process of starting power supply to the primary side demodulation chip 210 by the primary side control chip 100, the primary side demodulation chip 210 is kept powered to ensure that the primary side control chip 100 can effectively receive the switch control signal sent by the secondary side modulation chip 220, and the primary side control chip 100 can cooperate with the secondary side modulation chip 220 to adaptively power according to the output voltage V_{O} of the isolated converter, so that the primary side demodulation chip 210 can maintain its working state when the output voltage V_{O} needs to be adjusted, thereby improving the regulation efficiency of the output voltage V_{O}.

When the primary side control chip 100 does not receive the switch control signal, it controls the power supply of the primary side demodulation chip 210 to continue for a second preset time period before turning off, effectively avoiding the situation where the primary side demodulation chip 210 is powered off when there is a communication demand. In addition, the primary side control chip 100 can also turn off the power supply to the primary side demodulation chip 210 when the switch control signal is not received for a long time, avoiding the power waste of the primary side demodulation chip 210 and greatly improving energy utilization efficiency.

Thus, it can be seen that the embodiments of the present disclosure by adaptively controlling the VDP signal and VDS signal hiccup power supply, so that the corresponding I_{Q_SR} and I_{Q-P} become pulse currents, thereby reducing the average static current of the secondary side main control chip 300 and the primary side control chip 100, respectively, achieved low power consumption control. Wherein, the static current calculation of the secondary side modulation chip 220 under low power consumption adaptive control is shown in the following formula (1):

I_{Q_TX}=2 mA*t_{s_GR_width}/t_{s_GR} formula (1)

In the formula, I_{Q_TX} is the static current of the secondary modulation chip 220 under low power consumption adaptive control. If the pulse width t_{S_GR_width} of the VDS signal is set to 8 ms in the embodiment of the present disclosure, and the hiccup power supply period t_{S_GR} of the secondary side main control chip 300 in low power consumption mode is 300-500 ms, then the average static current of the secondary side modulation chip 220 is 40 μA. Consider that the control voltage of the secondary side modulation chip 220 in low power consumption mode drops to 4V, the power consumption of the secondary side modulation chip 220 under low power consumption adaptive control is about 0.2 mW.

The current calculation of the primary side demodulation chip 210 under low power consumption adaptive control is shown in the following formula (2):

I_{Q_RX}=1 mA*t_{P_GR_width}/t_{P_GR} formula (2)

In the formula, I_{Q_RX} is the static current of the primary side demodulation chip 210 under low power consumption adaptive control. If the pulse width t_{P_GR_width} of the VDP signal is set to 300 μs in the present embodiment, and the hiccup power supply cycle t_{P_GR} of the primary side demodulation chip 100 in low power consumption mode is 6 ms, then the average static current of the primary demodulation chip 210 is 50 μA. Consider that the control voltage of the primary side demodulation chip 100 drops to 8V in low power consumption mode, the power consumption of the primary side demodulation chip 210 is about 0.4 mW.

Therefore, in the embodiments of the present disclosure, the power consumption of the isolated communication unit 200 is reduced to 0.6 mW under low power consumption adaptive control. Compared with the static power consumption of up to 20 mW of the capacitive isolator itself, the power consumption of the isolated communication unit 200 can be controlled to decrease to 3%. In addition, consider that the static power consumption of other chips in the isolated converter is 1.2 mW and there is a 50% system efficiency loss, the overall power consumption of the isolated converter is about 3.6 mW, greatly reducing the static power consumption of the isolated converter in standby mode and meeting the “zero standby energy consumption” requirement of fast chargers with energy consumption below 5 mW.

In some embodiments of the present disclosure, when the secondary side main control chip 300 receives an instruction to exit low power consumption, the method further comprises: starting the power supply to the secondary side modulation chip 220, and sending the first wake-up signal to the primary side control chip 100 through the isolated communication unit 200, and sending the second wake-up signal to the primary side control chip 100 through the isolated communication unit 200 in the case that detecting the primary side reply of the isolated converter. The second wake-up signal is used to instruct the primary side control chip 100 to restore power supply.

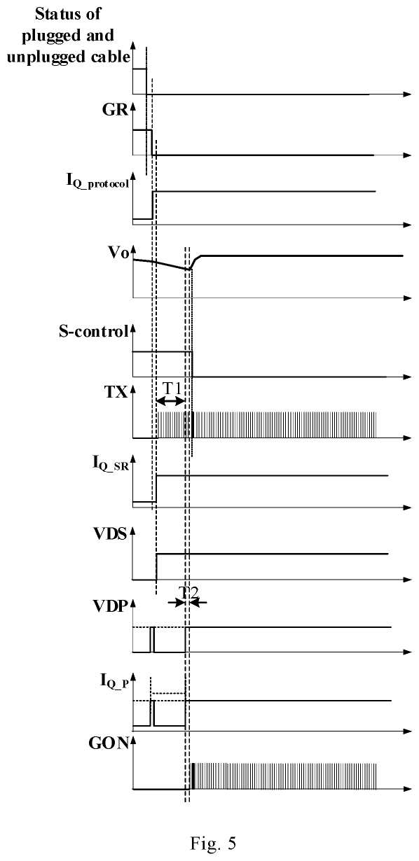

Specifically, as shown in FIG. 5, similarly, the static current I_{Q-P} of the primary side control chip 100 changes synchronously with the VDP signal of the primary side demodulation chip 210, and the static current I_{Q_SR} of the secondary side main control chip 300 changes synchronously with the VDS signal of the secondary side modulation chip 220. When the status signal of the plugged and unplugged cable at the output of the isolated converter is set to low level, the protocol chip will turn the GR signal into an invalid signal after a certain delay, that is, generate a command to exit low power consumption, and send the exit low power consumption command to the secondary side main control chip 300. At the same time, the protocol chip returns to normal working mode, so that the static current I_{Q_datocol} of the protocol chip is increased to 3.5 mA. When the secondary side main control chip 300 detects that the GR signal has become an invalid signal, it controls the secondary side modulation chip 220 to continuously send the first wake-up signal during T1 period according to a fixed peak pulse width to ensure normal communication between the primary side and secondary side. The primary side demodulation chip 210 receives the first wake-up signal during the period when VDP is placed at the power-on potential, and demodulates the first wake-up signal and sends it to the primary side control chip 100 to adjust the conduction state of the power switch transistor, thereby causing the output voltage V_{O} on the secondary side to change. When the secondary side main control chip 300 detects a change in the output voltage V_{O} on the secondary side, it determines that it has received a response from the primary side. Once the secondary side main control chip 300 receives a reply from the primary side, it immediately sends two consecutive pulse signals with a pulse width of 40 μs starting from the next TX signal transmission cycle as the second wake-up signal, thereby waking up the primary side control chip 100. After receiving a pulse signal of more than 10 μs during the T2 period, the primary side control chip 100 immediately exits the low power consumption mode and resumes continuous power supply to the primary side demodulation chip 210, that is, maintains VDP at the power-on potential of the primary side demodulation chip 210. Moreover, after the isolated converter wakes up, the GON signal also returns to its normal pulse frequency. Meanwhile, the S-control signal is set to a low level to restore the secondary side main control chip 300 to the normal operating mode.

Therefore, in some embodiments of the present disclosure, the secondary side main control chip 300 sends the first wake-up signal to the primary side control chip 100 through the isolated communication unit 200, and sends the second wake-up signal to the primary side control chip 100 in the case that determining the primary side reply, thereby achieving an orderly switching of the isolated converter from low power consumption mode to the normal operation mode, ensuring that the isolated converter can effectively recover to normal operation state, and meeting the requirement of the system to quickly recover from low power consumption state to the normal operation.

Correspondingly, refer to FIG. 2, embodiments of the present disclosure provide a control device 10 for an isolated converter, comprising a primary side control chip 100, an isolated communication unit 200, and a secondary main control chip 300. The primary side control chip 100 is configured to supply power to the primary side demodulation chip 210 of the isolated communication unit 200, and the secondary side main control chip 300 is configured to supply power to the secondary side modulation chip 220 of the isolated communication unit 200.

The secondary side main control chip 300 is also configured to respond to the low power consumption control instructions, send the low power consumption signal to the primary side control chip 100 through the isolated communication unit 200, and control the secondary side modulation chip 220 to perform hiccup power supply based on the output voltage of the isolated converter;

The primary side control chip 100 controls the primary side demodulation chip 210 to perform hiccup power supply based on regular inspections when receiving the low power consumption signal.

The control device 10 proposed in the embodiment of the present disclosure responds to low power consumption control instructions through the secondary side main control chip 300, and sends the low power consumption signal to the primary side control chip 100 through the isolated communication unit 200. The secondary side modulation chip 220 is controlled to perform hiccup power supply by the secondary side main control chip 300 based on the output voltage of the isolated converter. When the primary side control chip 100 receives the low power consumption signal, it controls the primary side demodulation chip 210 to perform hiccup power supply based on regular inspections; therefore, the present disclosure adopts a method of hiccup power supply to separately control the power supply of the primary side demodulation chip 210 and the secondary side modulation chip 220, avoiding the problem of high power consumption caused by continuous power supply. It can also dynamically adjust the power supply of the secondary side modulation chip 220 based on the output voltage of the isolated converter, and control the primary side demodulation chip 210 to perform hiccup power supply based on regular inspections, achieved adaptive control of the power supply status of the primary side demodulation chip 210 and the secondary side modulation chip 220. This not only significantly reduces the overall power consumption of the isolated converter, but also meets the normal communication requirements of the isolated converter, improves the adaptability of the system to different application scenarios, and meets the diversified needs of the isolated converter.

Furthermore, in some embodiments of the present disclosure, the secondary side main control chip 300 is further configured to start the power supply to the secondary side modulation chip 220 in the case that the output voltage of the isolated converter decreases to a first preset voltage threshold, so as to raise the output voltage of the isolated converter to a second preset voltage threshold, and then turn off power supply to the secondary side modulation chip 220, wherein the second preset voltage threshold is greater than the first preset voltage threshold.

The secondary side main control chip 300 dynamically turns on and turns off the power supply to the secondary side modulation chip 220 according to the output voltage of the isolated converter. When the output voltage is low, the power supply to the secondary side modulation chip 220 is turned on, which helps to increase the output voltage and ensure the normal operation of the system. When the output voltage rises to a certain level, turning off the power supply to the secondary side modulation chip 220 can avoid unnecessary power consumption of the secondary side modulation chip 220, achieve effective management of the power consumption of the secondary side modulation chip 220, further reduce the overall power consumption of the isolated converter, and improve energy utilization efficiency.

The secondary side main control chip 300 is also configured to send a switch control signal to the primary side control chip 100 through the isolated communication unit 200 in the case that the power supply to the secondary side modulation chip 220 is turned on, so that the primary side control chip 100 can control the power switch transistor of the isolated converter based on the switch control signal, causing the output voltage of the isolated converter to rise.

The secondary side main control chip 300 sends the switch control signal to the primary side control chip 100 through the isolated communication unit 200, so that the primary side control chip 100 can control the power switch transistor according to the switch control signal sent from the secondary side, and effectively adjust the output voltage of the isolated converter, ensuring that the output voltage can be raised in a timely and effective manner when the power supply of the secondary side modulation chip 220 is turned on, maintaining the output voltage of the system at an appropriate level, and ensuring the stable operation of the system.

The secondary side main control chip 300 is also configured to determine that a communication failure has occurred in the isolated converter if the primary side response of the isolated converter is not detected within the first preset time period in the case that the switch control signal is sent to the primary side control chip 100 through the isolated communication unit 200.

The secondary side main control chip 300 can detect communication abnormalities between the primary and secondary sides in a timely manner by detecting the primary side response of the isolated converter within the first preset time period. If the secondary side main control chip 300 does not receive the primary side response within the first preset time period, it determines the communication fault and facilitates the system to take corresponding measures timely, such as issuing an alarm, conducting fault investigation, or switching to a backup communication path, etc, which helps to ensure the reliability of the isolated converter communication and maintain the stable operation of the system.

Furthermore, in some embodiments of the present disclosure, the primary side control chip 100 is further configured to, during the process of turning on the power supply to the primary side demodulation chip 210, if a switch control signal sent by the secondary side modulation chip 220 is detected, the power supply to the primary side demodulation chip 210 is maintained until the primary side demodulation chip 210 does not receive the switch control signal and continues for a second preset time period, and then turn off the power supply to the primary side demodulation chip 210.

During the process of turning on the power supply to the primary side demodulation chip 210 by the primary side control chip 100, by maintaining power supply to the primary side demodulation chip 210, it is ensured that the primary side control chip 100 can effectively receive the switch control signal sent by the secondary side modulation chip 220. When the switch control signal is not received, the power supply to the primary side demodulation chip 210 is controlled to continue for a second preset time period before being turned off, effectively avoiding the situation where the primary side demodulation chip 210 is powered off when there is a communication demand. In addition, the primary side control chip 100 can also turn off the power supply to the primary side demodulation chip 210 when the switch control signal is not received for a long time, avoiding the waste of power consumption of the primary side demodulation chip 210 and greatly improving energy utilization efficiency.

Furthermore, the secondary side main control chip 300 is also configured to start power supply to the secondary side modulation chip 220 in the case that receiving a low power consumption exit instruction, and send a first wake-up signal to the primary side control chip 100 through the isolated communication unit 200. And in the case that a primary side reply from the isolated converter is detected, a second wake-up signal is sent to the primary side control chip 100 through the isolated communication unit 200, the second wake-up signal is used to indicate the primary side control chip 100 to restore the power supply.

The secondary side main control chip 300 sends the first wake-up signal to the primary side control chip 100 through the isolated communication unit 200, and sends the second wake-up signal to the primary side control chip 100 when the primary side reply is confirmed, thereby achieving the orderly switching of the isolated converter from low power consumption mode to normal working mode, ensuring that the isolated converter can effectively recover to normal working state, and meeting the requirement of the system to quickly recover from low power consumption state to normal operation.

The further functional descriptions of the above modules and units are the same as the corresponding embodiments, and will not be repeated here.

The control device 10 in this embodiment is presented in the form of functional units, which refer to ASIC (Application Specific Integrated Circuit) circuits, processors and memories that execute one or more software or fixed programs, and/or other devices that can provide the above functions.

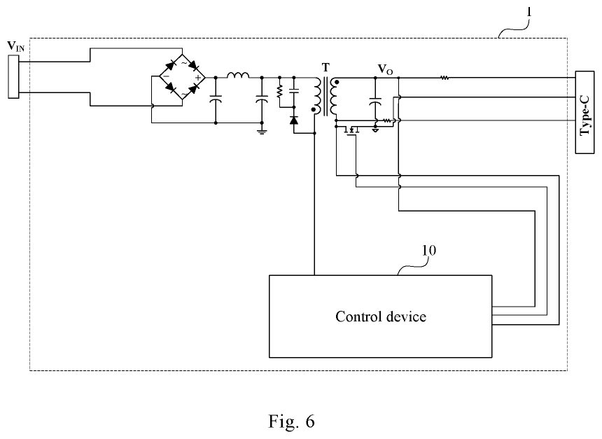

As shown in FIG. 6, the present embodiment also provides an isolated converter 1, including a transformer T, and a control device 10 of the isolated converter according to the above embodiment.

The further functional descriptions of the above modules and units are the same as those in the corresponding embodiments, and will not be repeated here.

The isolated converter 1 proposed in the embodiment of the present disclosure uses the above control device 10 to control the relevant modules in the isolated converter 1 to perform hiccup power supply, avoiding the problem of high power consumption caused by continuous power supply. It can also adaptively control the power supply of the relevant modules based on the output voltage V_{O} of the isolated converter 1, thereby significantly reducing the overall power consumption of the isolated converter 1 while meeting its normal communication requirements, improving the adaptability of the system to different application scenarios, and meeting the diversified needs of the isolated converter 1.

Furthermore, embodiments of the present disclosure provide an electronic device comprising isolated converter 1 described in the above embodiment.

The electronic device proposed in the embodiment of the present disclosure is capable of adaptive control of the isolated communication section in isolated converter 1, thereby significantly reducing the overall power consumption of isolated converter 1 while also meeting its normal communication requirements, enhancing the system's adaptability to different application scenarios, and meeting the diversified needs of isolated converter 1.

Although the embodiments of the present disclosure have been described in conjunction with the accompanying drawings, those skilled in the art may make various modifications and variations without departing from the spirit and scope of the present disclosure, and such modifications and variations fall within the scope defined by the appended claims.

For the convenience of description, the above devices are divided into various functional units and described separately. Of course, the functions of each unit can be implemented in the same or multiple software and/or hardware when implementing the present disclosure.

Those skilled in the art understand that the embodiments of the present disclosure can be provided as methods, systems, or computer program products. Therefore, the present disclosure may take the form of a full hardware implementation, a full software implementation, or a combination of software and hardware implementation. Moreover, the present disclosure may take the form of a computer program product implemented on one or more computer usable storage media (including but not limited to disk storage, CD-ROM, optical storage, etc.) containing computer usable program code.

The present disclosure is described with reference to the flowchart and/or block diagram of the method, device (system), and computer program product according to the embodiments of this application. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes in the flowchart and/or one or more blocks in the block diagram.

These computer program instructions can also be stored in computer-readable memory that can guide a computer or other programmable data processing device to operate in a specific manner, causing the instructions stored in the computer-readable memory to produce a manufactured product including instruction devices that implement the functions specified in one or more processes in the flowchart and/or one or more blocks in the block diagram.

These computer program instructions can also be loaded onto a computer or other programmable data processing device, causing a series of operational steps to be executed on the computer or other programmable device to produce computer implemented processing. The instructions executed on the computer or other programmable device provide the steps for implementing the functions specified in one or more processes in the flowchart and/or one or more blocks in the block diagram.

It should also be noted that the terms “comprise”, “include” or any other variation thereof are intended to encompass non-exclusive inclusion, such that a process, method, good or equipment that includes a series of elements not only includes those elements, but also includes other elements not explicitly listed, or also includes elements inherent to such process, method, good or equipment. Without further limitations, the element defined by the statement ‘comprise one . . . ’ does not exclude the existence of other identical elements in the process, method, product, or device that includes the above element.

The various embodiments in this specification are described in a progressive manner, and the same and similar parts between each embodiment can be referred to each other. Each embodiment focuses on the differences from other embodiments.

The above description is only an embodiment of the present disclosure and is not intended to limit the present disclosure. For those skilled in the art, this application may have various modifications and variations. Any modifications, equivalent substitutions, improvements, etc. made within the spirit and principles of the present disclosure shall be included within the scope of the claims of this application.

Although the embodiments of the present disclosure have been described in conjunction with the accompanying drawings, those skilled in the art may make various modifications and variations without departing from the spirit and scope of the present disclosure, and such modifications and variations fall within the scope defined by the appended claims.

What is claimed is:

1. A low power consumption adaptive control method of an isolated converter, wherein the isolated converter comprises a primary side control chip, an isolated communication unit, and a secondary side main control chip; the primary side control chip is configured to supply power to a primary side demodulation chip of the isolated communication unit, and the secondary side main control chip is configured to supply power to a secondary side modulation chip of the isolated communication unit, wherein the low power consumption adaptive control method comprises:
in response to a low power consumption control instruction, the secondary side main control chip sending a low power consumption signal to the primary side control chip through the isolated communication unit, so that the primary side control chip controls the primary side demodulation chip to perform hiccup power supply based on regular inspection, and the secondary side main control chip controls the secondary side modulation chip to perform hiccup power supply based on an output voltage of the isolated converter.

2. The low power consumption adaptive control method of claim 1, wherein controlling the secondary side modulation chip to perform hiccup power supply based on the output voltage of the isolated converter comprises:
in the case that the output voltage of the isolated converter decreases to a first preset voltage threshold, turning on power supply to the secondary side modulation chip, so that in the case that the output voltage of the isolated converter rises to a second preset voltage threshold, turning off the power supply to the secondary side modulation chip, wherein the second preset voltage threshold is greater than the first preset voltage threshold.

3. The low power consumption adaptive control method of claim 2, wherein, in the case that the power supply to the secondary side modulation chip is turned on, the method further comprises:
the secondary side main control chip sending the switch control signal to the primary side control chip through the isolated communication unit, so that the primary side control chip controls the power switch transistor of the isolated converter based on the switch control signal, causing the output voltage of the isolated converter to rise.

4. The low power consumption adaptive control method of claim 3, wherein in the case that the secondary side main control chip sends the switch control signal to the primary side control chip through the isolated communication unit, the method further comprises:
determining the isolated converter has a communication fault if the secondary side main control chip does not detect a primary side response of the isolated converter within a first preset time period.

5. The low power consumption adaptive control method of claim 1, wherein during a process that the primary side control chip turns on power supply to the primary side demodulation chip, if a switch control signal sent by the secondary side modulation chip is detected, the power supply to the primary side demodulation chip is maintained until the primary side demodulation chip does not receive the switch control signal and continues for a second preset time period, and the power supply to the primary side demodulation chip is turned off.

6. The low power consumption adaptive control method of claim 1, wherein in the case that the secondary side main control chip receives an instruction to exit low power consumption, the method further comprises:
turning on the power supply to the secondary side modulation chip, and sending a first wake-up signal to the primary side control chip through the isolated communication unit; and, in the case that the primary side reply of the isolated converter is detected, sending a second wake-up signal to the primary side control chip through the isolated communication unit; wherein the second wake-up signal is used to instruct the primary side control chip to restore power supply.

7. A control device of an isolated converter, comprising a primary side control chip, an isolated communication unit, and a secondary side main control chip; wherein the primary side control chip is configured to supply power to the primary side demodulation chip of the isolated communication unit, and the secondary side main control chip is configured to supply power to the secondary side modulation chip of the isolated communication unit, wherein,
the secondary side main control chip is further configured to respond to low power consumption control instructions, send a low power consumption signal to the primary side control chip through the isolated communication unit, and control the secondary side modulation chip to perform hiccup power supply based on an output voltage of the isolated converter;
the primary side control chip controls the primary side demodulation chip to perform hiccup power supply based on regular inspection in the case that receiving the low power consumption signal.

8. The control device of claim 7, wherein the secondary side main control chip is further configured to turn on the power supply to the secondary side modulation chip in the case that the output voltage of the isolated converter decreases to a first preset voltage threshold, and turn off the power supply to the secondary side modulation chip in the case that the output voltage of the isolated converter rises to a second preset voltage threshold, wherein the second preset voltage threshold is greater than the first preset voltage threshold.

9. The control device of claim 8, wherein the secondary side main control chip is further configured to, in the case that power supply to the secondary side modulation chip is turned on, send a switch control signal to the primary side control chip through the isolated communication unit, so that the primary side control chip controls the power switch transistor of the isolated converter based on the switch control signal, causing the output voltage of the isolated converter to rise.

10. The control device of claim 9, wherein the secondary side main control chip is further configured to, in the case of sending the switch control signal to the primary side control chip through the isolated communication unit, if the primary side response of the isolated converter is not detected within the first preset time period, determine that the isolated converter has a communication fault.

11. The control device of claim 7, wherein the primary side control chip is further configured to, during the process of turning on the power supply to the primary side demodulation chip, if a switch control signal sent by the secondary side modulation chip is detected, maintain the power supply to the primary side demodulation chip until the primary side demodulation chip does not receive the switch control signal and continues for a second preset time period, and turn off the power supply to the primary side demodulation chip.

12. The control device of claim 7, wherein the secondary side main control chip is further configured to, in the case that receiving an instruction to exit low power consumption, turning on the power supply to the secondary side modulation chip, and sending a first wake-up signal to the primary side control chip through the isolated communication unit, and, in the case that detecting a primary side reply from the isolated converter, sending the second wake-up signal to the primary side control chip through the isolated communication unit, wherein the second wake-up signal is used to instruct the primary side control chip to restore power supply.

13. An isolated converter, comprising:
a transformer;
the control device of an isolated converter of claim 7.
